(19) United States
(12) Patent Application Publication
(10) Pub. No.: US 2006/0076014 A1
(43) Pub. Date: Apr. 13, 2006

(54) Linear compressor

(75) Inventors: Choong Min Jung, Sungnam-si (KR); Dae Nyoung Heo, Kwangmyung-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/165,189

(22) Filed: Jun. 24, 2005

(30) Foreign Application Priority Data
Oct. 7, 2004 (KR) 2004-79941

(51) Int. Cl. A62B 9/02

(52) U.S. Cl. 128/205.24

(57) ABSTRACT

Disclosed herein is a linear compressor. In the present invention, a leaf spring is used for an exhale spring to support an exhale valve. As the leaf spring supports the exhale valve by being bended in a predetermined direction, the exhale valve can be stably opened and closed in the predetermined direction. As a space for the exhale spring becomes reduced in an inner exhale cover, a size of an exhale part is reduced, thus making it possible to produce the compact linear compressor. As the leaf spring is comprised of a plurality of overlapped plates, when the exhale valve is opened and closed, the leaf spring is bended, and friction is generated among the plurality of plates. Therefore, a vibration of the exhale valve is decremented by its friction, thus reducing a friction noise.

### BACKGROUND OF THE INVENTION

1. Field of the Invention

The present invention relates to a linear compressor, more particularly, in which a leaf spring is used for an exhale spring. With this configuration, the linear compressor is capable of reducing a space for the exhale spring, of controlling intensity of the exhale spring and an open direction of an exhale valve, and of decreasing a vibration and a noise occurred when the exhale valve is opened and closed.

2. Description of the Related Art

Generally, a linear compressor is a machine to inhale, to compress, and to discharge fluid by linearly reciprocating a piston within a cylinder, by means of linear driving force of a linear motor.

FIG. 1 shows the linear compressor, in accordance with the prior art, and FIG. 2 shows a structure of an exhale part of the linear compressor, in accordance with the prior art.

In a hermetic casing 2 of the conventional linear compressor, a cylinder block 4 connected to the cylinder 3, and a back cover 6 provided with an inlet 5 are equipped. The cylinder block 4 and the back cover 6 are upheld in the hermetic casing 2 by a main damper 7 and a subsidiary damper 8, so as to absorb a shock (see FIG. 1).

The linear motor 10 is mounted between the cylinder block 4 and the back cover 6, which generates driving force to compress fluid.

The linear motor 10 is divided by a stationary part and a movable part. The stationary part includes an outer core 11, an inner core 12, and a coil 13 with a magnetic field. The movable part includes a magnet 14 that linearly reciprocates by magnetic force around the coil 13, and a magnet frame 15 which the magnet 14 is fastened to.

The piston 16 is arranged in the cylinder 3, which receives linear driving force from the magnet 14, linearly reciprocates, and compresses fluid entered in the cylinder 3.

The piston 16 is fastened to the magnet frame 15 to receive linear driving force from the magnet 14. In a rear of the piston 16, a flange 17 is formed to be fixed to the magnet frame 15.

A main spring 18 is disposed between the flange 17 and the cylinder block 4, and a subsidiary spring 19 is disposed between the flange 17 and the back cover 6, so that the piston 16 is elastically suspended.

The piston 16 is in the shape of a cylinder, which is open at both sides. An inhale passage 20 where fluid is entered is provided therein, a plurality of inhale ports 21 and an inhale valve 22 for opening and closing the inhale ports 21 are provided in its front.

As the cylinder 3 is a cylindrical shape, which is open at its rear, the piston 16 is inserted into one end, and the exhale part 30 is equipped in the other end, so as to discharge compressed fluid. The piston 16 and the exhale part 30 make a compression chamber C.

The exhale part 30 includes an inner exhale cover 32 located in a front of the compression chamber C of the cylinder 3 and provided with an exhale hole 31, an outer exhale cover 35 positioned at a regular interval from an outer surface of the inner exhale cover 32, and an exhale valve 34 elastically suspended in the inner exhale cover 32 by an exhale spring 33, which opens and closes the compression chamber C of the cylinder 3 (see FIG. 2).

To form a space for buffing fluid discharged from the compression chamber C, the inner exhale cover 32 is in the shape of a cap. An exhale pipe 36 is connected to the outer exhale cover 35, which discharges fluid to the outside.

A conic coil spring, the exhale spring 33 is spirally wound, and is disposed between the inner exhale cover 32 and the exhale valve 34, so as to give the elasticity toward a direction that the exhale valve 34 closes the compression chamber C of the cylinder 3.

A spring sheet 37 is set in the inner exhale cover 32 to prevent against an abrasion, occurred by a repetitive load from the exhale spring 33.

One edge of the exhale spring is touched with the spring sheet 37, and the other is fixed by a protrusion protruded in the exhale valve 34.

The linear compressor having the conventional exhale part operates in the following sequence.

In operation of the linear motor 10, the magnet 14 linearly reciprocates, its linear driving force is delivered to the piston 16 through the magnet frame 15. The piston 16 continuously moves back and forth within the cylinder 3.

When the piston 16 moves backward, the inhale valve 22 becomes opened by a pressure difference of the inhale passage 20 and the compression chamber C. Fluid in the hermetic casing 2 is inhaled into the compression chamber C of the cylinder 3 through the inhale passage 20 of the piston 16. The exhale valve 34 closes the compression chamber C by the elasticity of the exhale spring 33.

Thereafter, when the piston 16 moves toward the exhale part 30, the inhale valve 22 becomes closed by the pressure difference of the inhale passage 20 and the compression chamber C.

Fluid in the compression chamber C is compressed by the piston 16, compressed fluid allows the exhale valve 34 to be opened, by recovering the elasticity of the exhale spring 33.

The exhale spring 33 is compressed in the direction of the piston 16, and the exhale valve 34 becomes opened.

When the exhale valve 34 is opened, fluid is discharged to the outside through the outer exhale cover 35 and the exhale pipe 36 after being discharged to the inner exhale cover 32.

As described above, as the piston 16 moves back and forth, compressing fluid within the compression chamber C and discharging are repeated.

However, in the conventional exhale part of the linear compressor, as the spirally wound coil spring is used for the exhale spring 33, the exhale spring 33 is unsymmetrical. With this configuration, the exhale valve 34 is unstably opened and closed in several direction, thereby reducing exhale efficiency. And, the exhale spring 33 rotates during its motion, and its position comes to change.

Furthermore, as the exhale spring 33 is in the shape of a cone, it requires a large space in the inner exhale cover 32, thereby hindering miniaturization of the linear compressor.

### SUMMARY OF THE INVENTION

Accordingly, it is an aspect of the present invention to provide a linear compressor, wherein a leaf spring holds an exhale valve, thus stably opening and closing the exhale valve, further improving exhale efficiency.

The foregoing and other aspects are achieved by providing the linear compressor, based on the present invention, which comprises an exhale cover where fluid drained through an opening of a cylinder is discharged, the exhale valve which opens and closes the opening, and an exhale spring set in the exhale cover to elastically hold the exhale valve. The exhale spring is the leaf spring.

The leaf spring is perpendicular to an open and close direction of the exhale valve, between the exhale cover and the exhale valve.

One end of the leaf spring is fastened to the exhale cover, and the other is combined with the exhale valve.

The exhale valve has a hanging portion protruded toward the exhale cover, and the leaf spring has a hanging hole to be inserted into the hanging portion.

The exhale cover includes an inner exhale cover set in the opening of the cylinder, and an outer exhale cover positioned at a regular interval from an outer surface of the inner exhale cover. The leaf spring is equipped between the exhale valve and the inner exhale cover.

The leaf spring is comprised of a plurality of overlapped plates having the elasticity.

A length of each plate of the leaf spring is different.

One end of at least one leaf spring is fastened to the exhale cover, and the other is combined with the exhale valve.

The hanging portion protruded toward the exhale cover is provided in the exhale valve, the hanging hole to be inserted into the hanging portion is provided in at least one leaf spring.

As the plate having a length longer in the leaf springs, it is disposed near the exhale valve.

In the linear compressor, according to the present invention, as the leaf spring is used for the exhale spring, the leaf spring becomes bended toward a predetermined direction, and it supports the exhale valve. The exhale valve is stably opened and closed in the predetermined direction. As a space for the exhale spring becomes reduced in the inner exhale cover, a size of the exhale part becomes reduced, so that it is possible to produce more compact linear compressor.

As the leaf spring is made of spring steel, a width, a length or a number of the plate are changeable. Intensity of the leaf spring can be controlled, depending on a user's intention.

As the leaf spring is comprised of the plurality of plates overlapped, when the exhale valve is opened and closed, the leaf spring becomes bended, and friction is occurred among the plates. As a vibration of the exhale valve is decremented by friction, a friction noise can be reduced.

The open direction of the exhale valve can be transferred, depending on where the leaf spring is fixed to the exhale cover.

### BRIEF DESCRIPTION OF THE DRAWINGS

These and other objects and advantages of the present invention will become apparent and more readily appreciated from the following description of the embodiments of the invention, taken in conjunction with the accompanying drawings of which:

FIG. 1 is a vertically sectional view of a linear compressor, according to the prior art;

FIG. 2 is a sectional view of a structure of an exhale part of the linear compressor, according to the prior art;

FIG. 3 is a vertically sectional view of the linear compressor, according to a 1^{st} embodiment of the present invention;

FIG. 4 is a sectional view of the structure of the exhale part of the linear compressor, according to the 1^{st} embodiment of the present invention;

FIG. 5 is a sectional view of an open state of an exhale valve, according to the 1^{st} embodiment of the present invention;

FIG. 6 is a sectional view of the structure of the exhale part of the linear compressor, according to a 2^{nd} embodiment of the present invention;

FIG. 7 is a sectional view of the open state of the exhale valve, according to the 2^{nd} embodiment of the present invention.

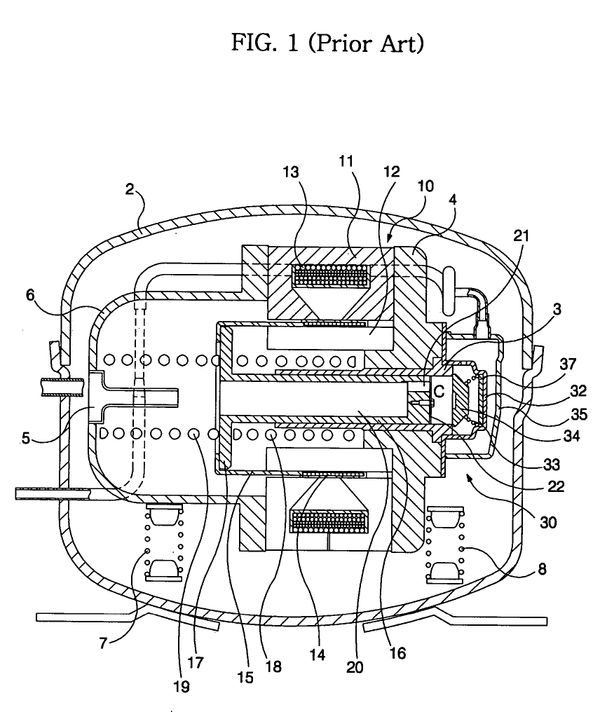

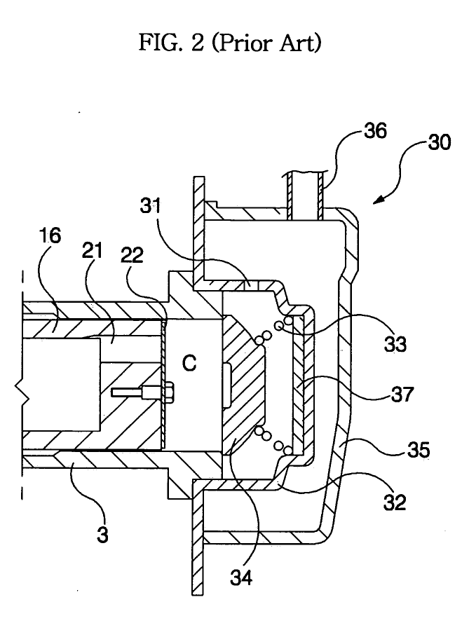

### DETAILED DESCRIPTION OF THE PREFERRED EMBODIMENT

Reference will now be made in detail to the embodiments of the present invention, examples of which are illustrated in the accompanying drawings, wherein like reference numerals refer to the like elements throughout. The embodiments are described below in order to explain the present invention by referring to the figures.

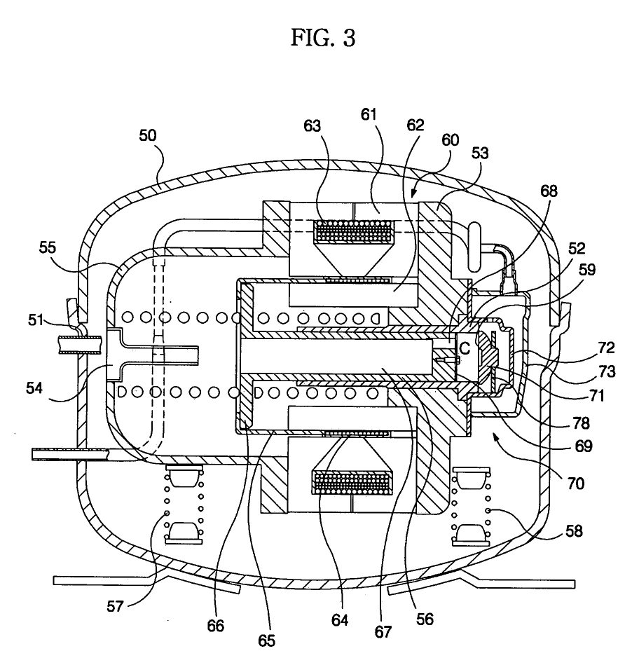

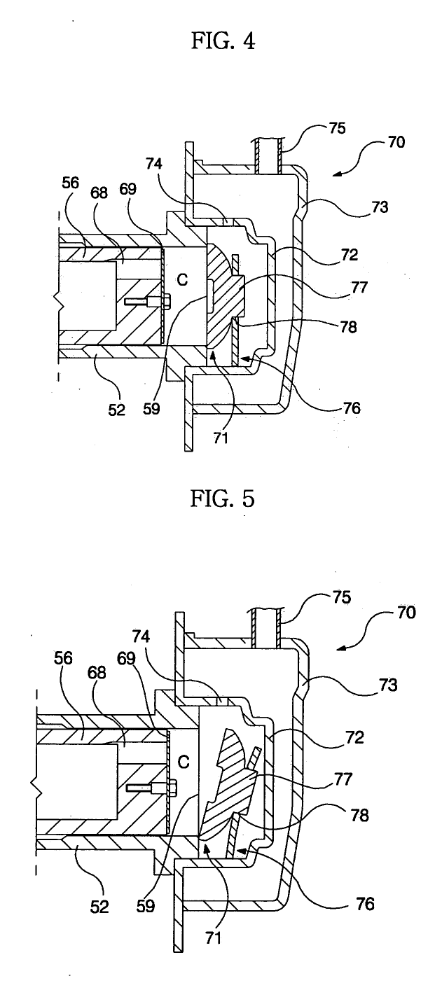

FIG. 3 shows a linear compressor, according to a 1^{st} embodiment of the present invention, FIG. 4 shows a structure of an exhale part, according to the 1^{st} embodiment of the present invention, and FIG. 5 shows an open state of an exhale valve, according to the 1^{st} embodiment of the present invention.

As referring to FIGS. 3 to 5, the linear compressor, in accordance with the present invention comprises a hermetic casing 50 having an inlet 51 where fluid is entered from the outside, and a linear compression part positioned in the hermetic casing 50 to compress fluid. The linear compression part includes a cylinder block 53 provided with a cylinder 52, a back cover 55 provided with an inhale pipe 54 where fluid within the hermetic casing 50 is inhaled, a piston 56 which compresses fluid by moving back and forth in the cylinder 61, and a linear motor 60 which generates driving force to make the piston 56 linearly reciprocate within the cylinder 52.

The cylinder block 53 and the back cover 55 are upheld in the hermetic casing 50 by a main damper 57 and a subsidiary damper 58, so as to absorb a shock.

The linear motor 60 is divided by a stationary part and a movable part. The stationary part includes an outer core 61, an inner core 62 spaced apart from the outer core 61 by predetermined distance, and a coil 63 with a magnetic field. The movable part includes a magnet 64 arranged between the outer core 61 and the inner core 62 to linearly reciprocate by magnetic force around the coil 63, and a magnetic frame 65 fastened to the magnet 64 and combined with the piston 56 to deliver linear driving force to the piston 56.

The piston 56 is in the shape of a cylinder, which is open at its rear. There is a flange 66 protruded outwardly to be fastened to the magnet frame 65. An inhale passage 67 is provided therein, which fluid is inhaled into.

In a front of the piston 56, a plurality of inhale ports 68 is formed, and an inhale valve 69 for opening and closing the inhale port 68 is installed.

The cylinder 52 is in the shape of a cylinder, which is open at both sides. Its rear is openably formed to insert the piston 56 for moving back and forth, and its front has an opening 59 to discharge fluid compressed by the piston 56. The exhale part 70 is placed in a front of the opening 59, and a compression chamber C is configured in the cylinder 52 by the piston 56 and the exhale part 70.

As shown in FIG. 4, the exhale part 70 includes an exhale cover which discharges fluid drained from the compression chamber C of the cylinder 52, the exhale valve 71 to open and close the compression chamber C, and an exhale spring set in the exhale cover to elastically support the exhale valve 71.

The exhale cover includes an inner exhale cover 72, and an outer exhale cover 73 arranged in the outside of the inner exhale cover 72 to make a predetermined space.

An exhale hole 74 is formed in the inner exhale cover 72, so as to discharge fluid within the inner exhale cover 72 to the outer exhale cover 73, and an exhale pipe 75 is connected to the outer exhale cover 73, so as to discharge drained fluid to the outside.

The exhale spring is a leaf spring 76 vertically set in an open and close direction of the exhale valve 71, between the inner exhale cover 72 and the exhale valve 71.

As the leaf spring 76 is made of spring steel, intensity is controllable, depending on a width or a length of a plate.

One end of the leaf spring 76 is fastened to the inner exhale cover 72, and the other is combined with the exhale valve 71, in order to elastically hold the exhale valve 71.

The exhale valve 71 has a hanging portion 77 protruded toward the inner exhale cover 72, and the leaf spring 76 has a hanging hole 78 to be inserted into the hanging portion 77. It is desirable that the leaf spring 76 is combined with the exhale valve 71 by inserting, and is fixed to the inner exhale cover 72 by adhering.

A process of the linear compressor, according to the 1^{st} embodiment of the present invention is described in the following.

When the linear motor 60 is in operation, the piston 56 linearly reciprocates within the cylinder 52.

When the piston 56 moves forward, the exhale valve 71 is pushed and is opened by the pressure of fluid compressed within the cylinder 52, and compressed fluid is discharged to the inner exhale cover 72.

When the exhale valve 71 is pushed by the pressure of compressed fluid, the leaf spring 76 is elastically bended, centering on its edge fastened to the inner exhale cover 72.

As the exhale valve 71 is elastically suspended by the leaf spring 76, it becomes opened toward a direction that the leaf spring 76 is bended.

When the exhale valve 71 is opened, compressed fluid is discharged to the inner exhale cover 72, and is discharged to the outer exhale cover 73 through the exhale hole 74, and to the outside through the exhale pipe 75.

Thereafter, when the piston 56 moves backward, the exhale valve 71 comes to be closed by recovering the elasticity of the leaf spring 76.

As describe above, the piston 56 moves back and forth, and the exhale valve 71 opens and closes the compression chamber C of the cylinder 52. Compressing fluid within the compression chamber C and discharging are repeated.

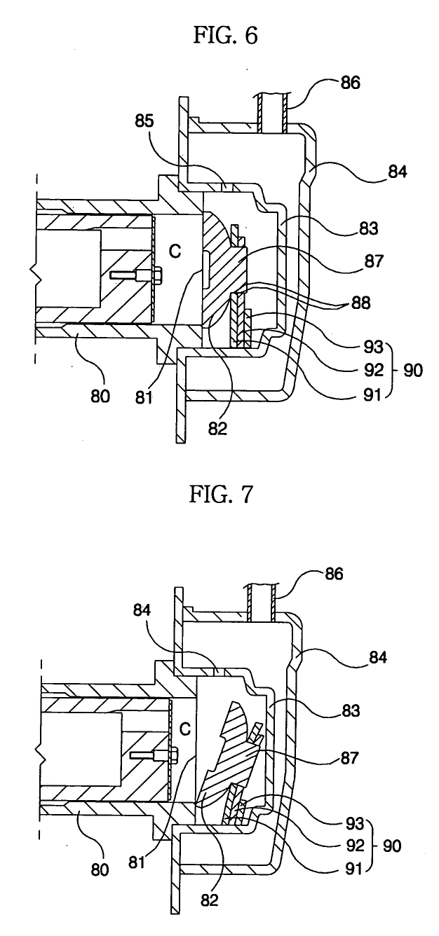

FIG. 6 shows the exhale part of the liner compressor, according to a 2^{nd} embodiment of the present invention, and FIG. 7 shows the open state of the exhale valve, according to the 2^{nd} embodiment of the present invention.

As referring to FIGS. 6 to 7, the exhale part of the linear compressor, according to the 2^{nd} embodiment of the present invention comprises an exhale cover where fluid drained from an opening 81 of a cylinder 80 is discharged, the exhale valve 82 to open and close the opening 81, and an exhale spring set in the exhale cover to elastically uphold the exhale valve 82.

The exhale cover includes an inner exhale cover 83, and an outer exhale cover 84 located in the outside of the inner exhale cover 83 to form the predetermined space. An exhale hole 85 is formed in the inner exhale cover 83, and an exhale pipe 86 is connected to the outer exhale cover 84.

The exhale spring is a leaf spring 90 vertically set in the open and close direction of the exhale valve 82, between the inner exhale cover 83 and the exhale valve 82. The leaf spring 90 is comprised of a plurality of spring steel plates overlapped.

One end of the leaf spring 90 is fastened to the inner exhale cover 83, and the other is combined with the exhale valve 82 by inserting.

The exhale valve 82 has a hanging portion 87 protruded toward the inner exhale cover 83, and at least one plate of the leaf spring 90 has a hanging hole 88 to be inserted into the hanging portion 87.

The case that three plates comprise the leaf spring 90 is explained as an example of the present invention. The leaf spring 90 is comprised of a 1^{st} plate 91, a 2^{nd} plate 92, and a 3^{rd} plate 93 with a respectively different length.

The 1^{st} plate 91 is the longest, while the 3^{rd} plate 93 is the shortest. The leaf spring 90 is formed by overlapping the 1^{st} plate 91, the 2^{nd} plate 92, and the 3^{rd} plate 93 in order. The 1^{st} plate 91 having the length longer is arranged near the exhale valve 82.

The 1^{st} plate 91 and the 2^{nd} plate 92 of the leaf spring 90 respectively have the hanging hole 88 to be inserted into the hanging portion 87. The 1^{st} plate 91 and the 2^{nd} plate 92 are combined with the exhale valve 82 by inserting, and only one end of the 3^{rd} plate 93 is fastened to the inner exhale cover 83.

When the exhale valve 82 is opened, the leaf spring 90 is elastically bended, centering on its edge fastened to the inner exhale cover 83.

As the leaf spring 90 is comprised of three plates, all of the plates 91, 92, 93 are bended, and elastically support the exhale valve 82. When all of the plates 91, 92, 93 are bended, friction is occurred among the plates, and a vibration is decremented by its friction. A friction noise can be reduced, occurred when the exhale valve 82 is opened and closed.

Without defining the above embodiments, by changing the width, the length, and the number of the plates of the leaf spring 90, intensity can be controlled as a user wants.

As apparent from the above description, the linear compressor of the present invention provides the leaf spring as the exhale spring. As the leaf spring is bended in a predetermined direction, and supports the exhale valve, the exhale valve can be stably opened and closed in the predetermined direction. As a space for the exhale spring becomes reduced in the inner exhale cover, a size of the exhale part is reduced, so that it is possible to compose more compact linear compressor.

As the leaf spring is made of spring steel, intensity of the leaf spring can be controlled, depending on the user's intention by changing the width, the length, or the number of the plates.

As the leaf spring is formed with the plurality of plates overlapped, when the exhale valve is opened and closed, the leaf spring is bended, and friction is occurred among the plates. The vibration of the exhale valve is decremented by its friction, and the friction noise can be reduced.

The open direction of the exhale valve can be changed, as the leaf spring is fastened to the exhale cover.

Although a few embodiments of the present invention have been shown and described, it would be appreciated by those skilled in the art that changes may be made in this embodiment without departing from the principles and spirit of the invention, the scope of which is defined in the claims and their equivalents.

The present disclosure relates to subject matter contained in Korean Application No. 10-2004-0079941, filed on Oct. 7, 2004, the contents of which are herein expressly incorporated by reference in its entirety.

What is claimed is:

1. A linear compressor comprising:
an exhale cover where fluid drained from an opening of a cylinder is discharged;
an exhale valve to open and close the opening; and
an exhale spring mounted in the exhale cover to elastically support the exhale valve,
Wherein the exhale spring is a leaf spring.

2. The linear compressor as set forth in claim 1, wherein the leaf spring is vertically set in an open and close direction of the exhale valve, said leaf spring being formed between the exhale cover and the exhale valve.

3. The linear compressor as set forth in claim 2, wherein one end of the leaf spring is fastened to the exhale cover, and the other end of said leaf spring is combined with the exhale valve.

4. The linear compressor as set forth in claim 3, wherein the exhale valve has a hanging portion protruded toward the exhale cover, and the leaf spring has a hanging hole to be inserted into the hanging portion.

5. The linear compressor as set forth in claim 4, wherein the exhale cover includes:
an inner exhale cover set in the opening of the cylinder; and
an outer exhale cover arranged in the outside of the inner exhale cover to form a predetermined space,
Wherein the leaf spring is disposed between the exhale valve and the inner exhale cover.

6. The linear compressor as set forth in claim 1, wherein the leaf spring is comprised of a plurality of overlapped plates having the elasticity.

7. The linear compressor as set forth in claim 6, wherein each of the plurality of plates has a different length in the leaf spring.

8. The linear compressor as set forth in claim 7, wherein one end of at least one leaf spring is fastened to the exhale cover, and the other end of said leaf spring is combined with the exhale valve.

9. The linear compressor as set forth in claim 8, wherein the exhale valve has a hanging portion protruded toward the exhale cover, and at least one leaf spring has a hanging hole to be inserted into the hanging portion.

10. The linear compressor as set forth in claim 6, wherein the leaf spring having the length longer plate is placed near the exhale valve.

11. A linear compressor comprising:
a hermetic casing;
a linear motor installed in the hermetic casing;
a cylinder block set in the linear motor and provided with a cylinder;
a piston which linearly reciprocates in the cylinder, by means of the linear motor; and
an exhale part located in a front of an opening of the cylinder to discharge fluid compressed within the cylinder,
Wherein the exhale part further includes:
an exhale cover where fluid drained from the opening of the cylinder is discharged;
an exhale valve to open and close the opening; and
a leaf spring mounted in the exhale cover to elastically support the exhale valve.

12. The linear compressor as set forth in claim 11, wherein the leaf spring is vertically set in an open and close direction of the exhale valve, said leaf spring being formed between the exhale cover and the exhale valve.

13. The linear compressor as set forth in claim 12, wherein one end of the leaf spring is fastened to the exhale cover, and the other end of said leaf spring is combined with the exhale valve.

14. The linear compressor as set forth in claim 13, wherein the exhale valve has a hanging portion protruded toward the exhale cover, and the leaf spring has a hanging hole to be inserted into the hanging portion.

15. The linear compressor as set forth in claim 14, wherein the exhale cover includes:
an inner exhale cover set in the opening of the cylinder; and
an outer exhale cover arranged in the outside of the inner exhale cover to form a predetermined space,
Wherein the leaf spring is disposed between the exhale valve and the inner exhale cover.

16. The linear compressor as set forth in claim 11, wherein the leaf spring is comprised of a plurality of overlapped plates having the elasticity.

17. The linear compressor as set forth in claim 16, wherein each of the plurality of plates has a different length in the leaf spring.

18. The linear compressor as set forth in claim 17, wherein one end of at least one leaf spring is fastened to the exhale cover, and the other end of said leaf spring is combined with the exhale valve.

19. The linear compressor as set forth in claim 18, wherein the exhale valve has a hanging portion protruded toward the exhale cover, and at least one leaf spring has a hanging hole to be inserted into the hanging portion.

20. The linear compressor as set forth in claim 16, wherein the leaf spring having the length longer plate is placed near the exhale valve.
